(19) United States
(12) Patent Application Publication
(10) Pub. No.: US 2013/0326848 A1
(43) Pub. Date: Dec. 12, 2013

(54) LOAD SECURING DEVICE

(71) Applicant: Joseph L. Strahl, Gold Hill, OR (US)

(72) Inventor: Joseph L. Strahl, Gold Hill, OR (US)

(21) Appl. No.: 13/491,140

(22) Filed: Jun. 7, 2012

(51) Int. Cl. B60P 7/08; A44B 11/06

(52) U.S. Cl. CPC B60P 7/0823; A44B 11/065
USPC 24/69 ST; 24/68 E

(57) ABSTRACT

A strap attachment device has a frame with a releasable strap clamp located on each end. When combined with one or two straps the strap attachment device can be used to quickly secure loads in a flexible manner.

### BACKGROUND OF THE INVENTION

Cam straps are commonly used to secure items, and in river rafting are considered crucial equipment. A rafter will typically carry multiple cam straps having different lengths in order to secure different size objects. The current cam straps have a buckle which has one end of an elongate flat strap permanently attached to one of its ends. The other end of the buckle contains a strap clamp into which the other end of the strap can be inserted. The strap clamp allows a strap end to be pulled through it but prevents the strap from being pulled back out of the strap clamp without the strap clamp intentionally being released.

While cam straps are very effective as a way to easily secure a load quickly they have several shortcomings. Because one end of the strap is permanently attached to the buckle, if the strap breaks the buckle must be discarded along with the strap, even though the buckle is still operable and is more expensive than the strap. In addition, because each buckle is permanently attached to a strap if the strap is too short a completely new cam strap must be used. Also, because the straps and buckles are permanently joined, when several cam straps are stored in a single bag they can become tangled together. Finally, because cam straps often must be installed quickly under stressful conditions it is common to install them with the strap twisted or in a manner that they must be tightened by pulling the end of the strap away from the user's body, which makes it difficult to fully tighten the cam strap.

### SUMMARY OF THE INVENTION

The subject invention provides a strap attachment device which comprises a frame having a releasable strap clamp located at each end. The strap attachment device is combined with straps to provide a load securing device in which strap attachment devices and straps can be combined in a far more flexible manner than is possible with the prior art cam straps.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a perspective view of a strap attachment device of the subject invention;

FIG. 2 is a cross sectional view, at an enlarged scale, taken along the line 2-2 of FIG. 1;

FIG. 3 shows how the strap attachment device is used with two straps;

FIG. 4 shows how the strap attachment device is used with one strap.

### DETAILED DESCRIPTION OF PREFERRED EMBODIMENTS

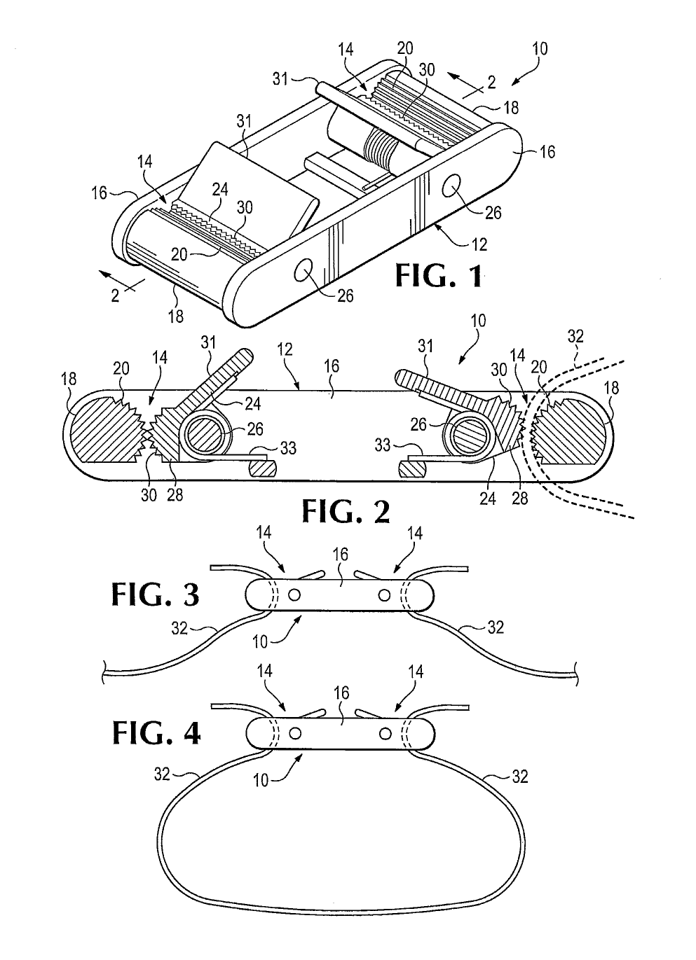

Referring now to FIGS. 1 and 2 of the drawings, a strap attachment device 10 has an elongate frame 12 with a strap clamp 14 located at each end. In the embodiment shown in the drawings the strap clamps are cam buckles. In the embodiment shown in the drawings the frame 10 has a pair of parallel side by side plates 16 which are joined at each end by spacer bars 18. The sides of the spacer bars facing inwardly toward one another contain a plurality of teeth 20. The strap clamps 14 include the spacer bars 18 along with clamps 24 which rotate about axels 26 which extend between the frame plates 16 inwardly of the spacer bars. The clamps 24 include clamping heads 28 which have teeth 30 that intermesh with the teeth 20 on the spreader bars 18. Handles 31, which are attached to the clamping heads, extends inwardly and upwardly from the axels 26. The handles allow the clamps 24 to be rotated between a closed position, shown in the left hand clamp in FIG. 1, where the teeth 30 on the clamping head 28 mesh with the teeth 20 on the spreader bar 18, and an open position, shown in the right hand clamp in FIG. 1, where the teeth 30 are separated from the teeth 20. Springs 33 urges the clamps towards their closed position to grip a strap 32 which extends through them. One of the strap attachment devices 10 in conjunction with one or two thin elongate straps 32 creates a load securing device. The straps are typically flat nylon or polypropylene webbing and are one half inch to two inches or even three inches wide, and 0.040 to 0.080 inches thick. However, larger straps could be used to secure larger loads. The width of the straps is preferably slightly less than the length of the spacer bar 18.

Unlike single cam straps of the prior art, the straps are not permanently attached to the strap attachment device 10. When the strap attachment device 10 is used with a single strap 32, FIG. 4, one end of the strap is inserted into the strap clamp 14 at one end of the strap attachment device 10, and the other end of the strap is wrapped around the load being secured (not shown) and is inserted into the strap clamp 14 at the opposite end of the strap attachment device. Either or both ends of the strap can then be pulled through the strap clamp to tighten the strap against the load being secured.

When the strap attachment device 10 is used with two straps, FIG. 3, one end of one of the straps is inserted into the strap clamp at one end of the strap attachment device 10 and one end of the other strap is inserted into the strap clamp 14 at the opposite end of the strap attachment device. The other ends of the straps can be inserted into another strap attachment device 10 or otherwise attached to one another or to another structure.

In either case the teeth 20 and 30 engage the strap and prevent it from being pulled back through the respective strap clamps. When it is desired to release the device one or both of the handles can be pushed to rotate the clamps to their open positions to release the straps.

Not having the strap attachment device 10 permanently attached to a strap provides much more flexibility than with the prior art strap clamps where one of the strap clamps is permanently attached to the clamping device. For example, a strap attachment device can be used with straps of different lengths rather than only being used with the strap attached to it. In addition, it is much easier to fix a twisted strap with the strap attachment device of the subject invention than it is with the prior art strap clamps. Likewise with the subject strap attachment device one end of the strap will always be passed through the device toward the user rather than away from the user and that end can be pulled by the user to tighten the strap. Finally, with the strap attachment device 10 of the subject invention a broken strap does not necessitate discarding the entire clamping device, which is the case with the prior art cam straps.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A strap attachment device comprising a frame having a releasable strap clamp located at each end thereof.

2. The strap attachment device of claim 1 wherein said releasable strap clamps are oriented to receive straps coming from opposite ends of said strap attachment device.

3. The strap attachment device of claim 1 wherein said strap clamps are cam buckles.

4. A load securing device comprising:
a. a strap attachment device having a releasable strap clamp located at opposed ends thereof;
b. a thin elongated strap having a first end and a second end;
c. said strap and said releasable strap clamps being configured such that said first end of said strap can be releasably attached to one of said strap clamps and said second end of said strap can be releasably attached to the other of said strap clamps.

5. The load securing device of claim 4 wherein said strap clamps are cam buckles.

6. A load securing device comprising:
a. a strap attachment device having a releasable strap clamp located at opposite ends thereof;
b. a first strap having an end which is configured to be received by and secured to one of said releasable strap clamps; and
c. a second strap having an end which is configured to be received by and secured to the other of said releasable strap clamps.

7. The load securing device of claim 6 wherein said strap clamps are cam buckles.

8. A load securing device comprising:
a. a frame having a first end and an opposed second end;
b. a first releasable strap clamp located at said first end of said frame, said first strap clamp being oriented to receive an end of a strap coming from said first end of said frame; and
c. a second strap clamp located at said second end of said frame, said second strap clamp being oriented to receive an end of a strap coming from said second end of said frame.

9. The load securing device of claim 8 wherein said strap clamps are cam buckles.

10. An attachment device comprising:
a. a frame having a first end and an opposed second end;
b. a thin elongated strap having a first end and a second end;
c. a first releasable strap clamp located at said first end of said frame, said first strap clamp being configured to receive and hold said first end of said strap; and
d. a second releasable strap clamp located at said second end of said frame, said second strap clamp being oriented to receive and hold said second end of said strap.

11. The attachment device of claim 10 wherein said strap clamps are cam buckles.
